(19) United States
(12) Patent Application Publication
(10) Pub. No.: US 2024/0313553 A1
(43) Pub. Date: Sep. 19, 2024

(54) SMART CHARGER FOR RECHARGEABLE ELECTRONIC DEVICE

(71) Applicant: PHILIP MORRIS PRODUCTS S.A., Neuchâtel (CH)

(72) Inventors: Igor Raymond Antoine Duc, Hong Kong (CN); Cedric Leclerc, Lausanne (CH); Fabien Lienard, Riex (CH); Richard Milhe, Divonne-les-Baines (FR)

(21) Appl. No.: 18/271,696

(22) PCT Filed: Jan. 13, 2022
(86) PCT No.: PCT/EP2022/050591

§ 371 Date: Jul. 11, 2023

(30) Foreign Application Priority Data
Jan. 15, 2021 (EP) 21151878.2

(51) Int. Cl. H02J 7/00; H02J 7/34

(52) U.S. Cl. CPC H02J 7/0042; H02J 7/00034; H02J 7/0036; H02J 7/342

(57) ABSTRACT

The invention relates to a charging device (10) for a rechargeable electronic device comprising a housing (12) with electronic circuitry including a control unit and a rechargeable battery, and at least two connection cables (20,22). The first end of each connection cable is electrically connected to the electronic circuitry within the housing of the charging device, and the second end of each cable being provided with a connector (24, 26), wherein the connectors at the second ends of the connection cables are identical. The invention also relates to a method of handlin a char in device.

The present invention relates to a charging device for a rechargeable electronic device. The charging device comprises a housing with electronic circuitry including a control unit and a rechargeable battery, and at least two connection cables for connecting the charging device to a rechargeable electronic device. The invention also relates to a system comprising a charging device and a rechargeable electronic device, as well as to a method of handling a charging device.

Smart charging devices comprising a control unit and connection cables to connect the charging device to an electronic device to be recharged are well known in the art. Prior art charging devices typically comprise a first connection cable that is configured for connection to the electronic device to be recharged. The charging devices often comprise a second connection cable that is configured for connection to an external power source. When the charging device is connected to both, a power source and a rechargeable device, the power provided by the power source is used to charge the rechargeable device. In conventional devices the connection cables are unidirectional. In order to avoid wrong connection of the devices, the connection cables are provided with different connectors such that each cable is either connectable to a power source or to a rechargeable device.

It would be desirable to provide a smart charging device that is equally safe or even safer to handle than conventional charging devices. It would be desirable to provide a smart charging device that offers increased flexibility over conventional charging devices.

According to an embodiment of the present invention there is provided a charging device for a rechargeable electronic device. The charging device comprises a housing with electronic circuitry including a control unit and a rechargeable battery, and at least two connection cables. The first end of each connection cable is electrically connected to the electronic circuitry within the housing of the charging device. The second end of each cable is provided with a connector, wherein the connectors at the second ends of the connection cables are identical.

The control unit of the charging device may be configured to detect whether a power source or a rechargeable electronic device is connected to any of the charging cables of the charging device.

As used herein the expression “secondary electronic device” is used to denote electronic devices that are connectable to the charging device of the present invention. A secondary electronic device may be a power source or a rechargeable electronic device.

The control unit of the charging device is further configured to control the charging process based on the detection of the type of the connected device. The control unit may be configured to enable, disable and monitor charging operation. This functionality may increase handling of the charging device. Erroneous connection of secondary devices to the charging device is efficiently prevented. The charging device is configured to detect which kind of secondary electronic device has been connected to it. After this detection, the charging device initiates the appropriate action.

The control unit of the charging device may be configured to detect that a rechargeable electronic device is connected to one of the connection cables. The control unit may be further configured to charge such connected rechargeable electronic device. The rechargeable electronic device may be recharged by using electrical energy stored in the internal rechargeable battery of the charging device.

The connection cables and the electronic circuitry of the charging device are configured for bi-directional use. Thus, each of the connection cables can be used to connect an external power source or a rechargeable electronic device. Each of the connection cables may allow for charge flow in either direction.

The control unit of the charging device may be configured to detect that an external power source is connected to one of the connection cables. The control unit may be further configured to allow charging of the internal rechargeable battery from such connected external power source.

The charging device may be a portable charging device.

The rechargeable electronic device to be charged may be a portable rechargeable electronic device. In an embodiment the rechargeable electronic device may be a portable electronic aerosol-generating device.

The present invention is particularly useful for charging of portable electronic devices. Should a recharge be needed for a portable electronic device, such portable electronic device may be connected to the charging device of the present invention. If an external power source is available, electrical energy from such power source may be used for charging. If no external power source is available, electrical energy from the internal rechargeable battery of the charging device may be used for charging. The user can simply connect the rechargeable electronic device to any connector of the charging device. The control unit of the charging device will then detect the type of the connected device and will then take the appropriate action.

The connectors of the charging device of the present invention are identical. This means the connectors have the same construction and the same size. Accordingly, either of these connectors can be used to connect a rechargeable electronic device. Moreover, either of these connectors can be used to recharge a rechargeable electronic device. Each connector cable may be configured for charging and discharging processes. The smart charging device of the present invention allows charging of a rechargeable device independent on to which connection cable the rechargeable device is connected. This significantly increases usability of the charging device.

Usability of the charging device is further increased by using symmetrical connectors. Symmetrical connectors offer the advantage that such connectors can be connected in plural orientations. Use of such symmetric connectors may increase in particular handling of portable devices. Portable devices may be used in situations in which the user's view field is focused on other tasks, and connection of devices has to be carried out without looking. In such situations the use of symmetrical connectors makes it easier to connect the devices to each other.

The connectors of the charging device may be identical USB type connectors. The connectors of the charging device may be USB Type-C connectors. USB Type-C connectors have symmetrical construction.

The housing of the charging device may have any suitable shape. The housing of the charging device may have an elliptical or oval cross-section. In particular when the charging device is used as a portable charging device an elliptical or oval cross-section may allow the device to be more pocketable and may be generally easier to handle, than previously known more bulky devices.

The housing of the charging device may be made from any suitable material. The housing of the charging device may be made from synthetic material or from polymeric material.

The charging device may further be configured to hold the connection cables, at least partially, inside the housing. This may be particularly useful when the charging device is not in use. The connection cables may be safely stowed in the housing, when the charging device is carried in a user's pocket. In this way, the connection cables are protected during transport. At the same time the cables are prevented from getting entangled with each other.

The charging device may be configured such that the connection cables are wound inside the housing of the charging device. The connection cables may be wound inside the housing of the charging device along one rotation axis. The connection cables may be wound manually along one rotation axis. The housing may also comprise a winding mechanism for winding the connection cables. Such winding mechanism may allow to easily pull the connection cables out of the housing. The winding mechanism may further be configured to wind up the connection cables after use. This again makes handling of the charging device easier.

The charging device may be further configured such that the connectors are partially comprised within the housing, when the connection cables are fully wound up inside the housing of the charging device. The housing may comprise recesses at the outer surface of the housing. The recesses may be configured such that each connector is at least partially held in one of the recesses, when the connection cables are fully wound up inside the housing.

The charging cables may have a length of 50 to 300 millimeters. The charging cables may have a length of 100 to 200 millimeters.

The charging device may be configured to bi-directionally transfer data between connected devices. The data may be transferred via the connection cables. The charging device may be configured to bi-directionally transfer data between connected devices wirelessly. The data to be transferred may pertain to the charging process. The data to be transferred may be advantageously used to adapt the charging parameters to the status of the momentarily used electronic devices.

The charging device may comprise further features that allow better control on the charging process. Some or all of these features may be used to increase safety of the charging process.

The charging device may comprise InterChip USB (USB IC) to communicate to portable device the maximum output current available from power source. The charging device may further comprise a short circuit and overcurrent/overvoltage protection (OCP/OVP). The use of such protective circuits may allow to detect defective USB cables or defective devices. As a consequence the charging device may be configured to suspend power delivery to such defective devices.

The charging device may also use further protection circuits such as overcurrent protection, overvoltage protection and overheating protection to prevent other abnormal charging functions of the charging device.

The charging device may further comprise a user interface. The user interface may comprise light emitting diodes or a screen. The user interface may allow control of physically or wirelessly connected devices. The user interface may display information on the status of the charging operation. The user interface may display other useful information related to the status of any of the connected devices.

The present invention is also directed to a system comprising a charging device as described above and a rechargeable electronic device being connectable to the charging device. In an embodiment the rechargeable electronic device may be a rechargeable electronic aerosol-generating device. The rechargeable electronic device may be a portable device.

The present invention is also directed to a method of handling a charging device. The charging device comprises a housing with electronic circuitry including a control unit and a rechargeable battery, and at least two connection cables. The first end of each connection cable is electrically connected to the electronic circuitry within the housing of the charging device. The second end of each cable is provided with an identical connector. The method comprises the steps of connecting at least one of the cables to a rechargeable electronic device or a power source, detecting, by the control unit, whether the cable is connected to a rechargeable electronic device or a power source, and initiating the charging process after connection of one of the cables to the rechargeable electronic device or the power source.

Upon detection that a power source is connected to the charging device, the electric energy provided by such power source may be used for a charging process.

Upon detection that only a power source is connected to the charging device, the electric energy provided by such power source may be used to charge the internal rechargeable battery of the charging device.

Upon detection that only a rechargeable electronic device is connected to the charging device, the rechargeable electronic device may be charged using electric energy from the rechargeable battery of the charging device.

With the above functionality the method of the present invention makes handling of the charging device easier compared with existing charging methods. Erroneous connection of secondary devices to the charging device is efficiently prevented. The charging device is configured to detect which kind of secondary device has been connected to it. After this detection, the charging device initiates the appropriate action.

According to an embodiment, the method may further comprise connecting the two connection cables to two secondary electronic devices and detecting, by the control unit, whether the two connected secondary electronic devices are two power sources, two rechargeable electronic devices to be charged or whether the two connected secondary electronic devices are one power source and one rechargeable electronic device to be charged.

Upon detection that the two connected secondary devices are two power sources, the internal rechargeable battery may be charged from the first power source connected to the charging device. In this case, the second power source may not be used for charging. Alternatively, electric energy from both power sources may be used to charge the internal rechargeable battery of the charging device. The charging process may be stopped when the internal rechargeable battery of the charging device is fully charged. By blocking the second power source a risk of short circuiting the two power sources is avoided.

Alternatively, electric energy from both power sources may be used to charge the internal rechargeable battery of the charging device. In that case it has to be made sure that an inadvertent short circuiting of the two power sources is avoided.

Upon detection that the two connected secondary devices are two rechargeable portable devices, the rechargeable portable device that was first connected to the charging device may be charged. When charging of this rechargeable portable device is completed, the other rechargeable portable device may be charged. The charging process may be stopped when both rechargeable portable devices are fully charged.

Upon detection that the two connected secondary devices are a power source and a portable device, the method allows for automatically determining which of the secondary devices is to be charged and starting the charging process of the rechargeable portable device, using the electrical energy provided by the connected power source. When charging of the rechargeable portable device is completed, the internal rechargeable battery of the charging device may be charged using the electric energy provided by the connected power source. The charging process may be stopped when the rechargeable portable device and the internal rechargeable battery of the charging device are fully charged.

With the charging method of the present invention handling of the charging device is made substantially easier. The user does not have to pay attention which secondary electronic device is connected to which connector of the charging device. The control unit of the charging device is configured to detect on its own the type of secondary electronic device that is connected to one or both of the connectors of the charging device. The control unit of the charging device therefore automatically performs the correct charging task, independent from which secondary device is connected to which connector.

Below, there is provided a non-exhaustive list of non-limiting examples. Any one or more of the features of these examples may be combined with any one or more features of another example, embodiment, or aspect described herein.

Example A: Charging device for a rechargeable electronic device comprising
a housing with electronic circuitry including a control unit and a rechargeable battery, and
at least two connection cables,
   wherein the first end of each connection cable is electrically connected to the electronic circuitry within the housing of the charging device, and the second end of each cable being provided with a connector, and wherein the connectors at the second ends of the connection cables are identical.

Example B: Charging device according to example A, wherein the charging device is a portable charging device.

Example C: Charging device according to any one of the preceding examples, wherein the rechargeable electronic device to be charged is a portable rechargeable electronic device, preferably a portable electronic aerosol-generating device.

Example D: Charging device according to any one of the preceding examples, wherein the rechargeable electronic device to be charged is a portable electronic aerosol-generating device.

Example E: Charging device according to any one of the preceding examples, wherein the connectors are USB type connectors, preferably USB Type-C connectors.

Example F: Charging device according to any one of the preceding examples, wherein the connectors are USB Type-C connectors.

Example G: Charging device according to any one of the preceding examples, wherein the control unit is configured to detect that a rechargeable electronic device is connected to one of the connection cables, and wherein the control unit is further configured to charge such connected rechargeable electronic device.

Example H: Charging device according to any one of the preceding examples, wherein the control unit is configured to detect that a power source is connected to one of the connection cables, and wherein the control unit is further configured to allow charging of the internal rechargeable battery from such connected power source.

Example I: Charging device according to any one of the preceding examples, wherein the control unit is configured to enable, disable and monitor charging operation.

Example J: Charging device according to any one of the preceding examples, wherein the charging device is configured to bi-directionally transfer data between connected devices.

Example K: Charging device according to any one of the preceding examples, wherein the charging device is configured to bi-directionally transfer data between connected devices wirelessly.

Example L: Charging device according to any one of the preceding examples, wherein the housing of the charging device has an elliptical or oval cross section.

Example M: Charging device according to any one of the preceding examples, wherein when the device is not in use, the connection cables are wound inside the housing of the charging device.

Example N: Charging device according to any one of the preceding examples, wherein the connection cables are wound inside the housing of the charging device along one rotation axis.

Example O: Charging device according to any one of the preceding examples, wherein the connectors are partially comprised within the housing, when the connection cables are fully wound up inside the housing of the charging device.

Example P: Charging device according to any one of the preceding examples, wherein the charging device further comprises indication means to inform a user about a charge state of the internal battery.

Example Q: Charging device according example P, wherein the indication means comprise a rich user interface or a screen.

Example R: System comprising a charging device according to any one of the preceding examples and a rechargeable electronic device being connectable to the connectors of the connection cables of the charging device.

Example S: System according to example R wherein the rechargeable electronic device is a rechargeable electronic aerosol-generating device.

Example T: Method of handling a charging device, the charging device comprising
a housing with electronic circuitry including a control unit and a rechargeable battery, and
at least two connection cables,
   wherein the first end of each connection cable is electrically connected to the electronic circuitry within the housing of the charging device, and the second end of each cable being provided with a connector, and wherein the connectors at the second ends of the connection cables are identical;
the method comprising
connecting at least one of the cables to a rechargeable electronic device or a power source,
detecting, by the control unit, whether the cable is connected to a rechargeable electronic device or a power source,
initiating the charging process after connection of one of the cables to the rechargeable electronic device or the power source.

Example U: Method according to example T, wherein upon detection that a power source is connected to the charging device, the power provided by such power source is used for a charging process.

Example V: Method according to any one of examples T or U, wherein upon detection that only a power source is connected to the charging device, using the power provided by such power source to charge the internal rechargeable battery of the charging device.

Example W: Method according to example T, wherein upon detection that a rechargeable electronic device is connected to the charging device, the rechargeable electronic device is charged from the rechargeable battery of the charging device.

Example X: Method according to any one of examples T to W, comprising
connecting the two connection cables to two devices, and
detecting, by the control unit, whether the devices are two power sources, two portable devices to be charged or whether the devices are one power source and one portable device to be charged.

Example Y: Method according to example X, wherein upon detection that the two devices are two power sources, charging the internal rechargeable battery from the first power source connected to the charging device.

Example Z: Method according to example X, wherein upon detection that the two devices are two rechargeable portable devices, charging the rechargeable portable device that is first connected to the charging device.

Example AA: Method according to example X, wherein upon detection that the two devices are a power source and a portable device, automatically determining which device is to be charged and starting the charging process of the portable device, using the power provided by the connected power source.

Example AB: Method according to example AA, wherein upon detection that the portable device is fully charged, starting charging of the internal rechargeable battery, using the power provided by the connected power source.

Example AC: Method according to any one of examples T to AB, comprising stopping the charging process when the rechargeable portable device and the internal rechargeable battery are fully charged, respectively.

Features described in relation to one embodiment may equally be applied to other embodiments of the invention.

The invention will be further described, by way of example only, with reference to the accompanying drawings in which:

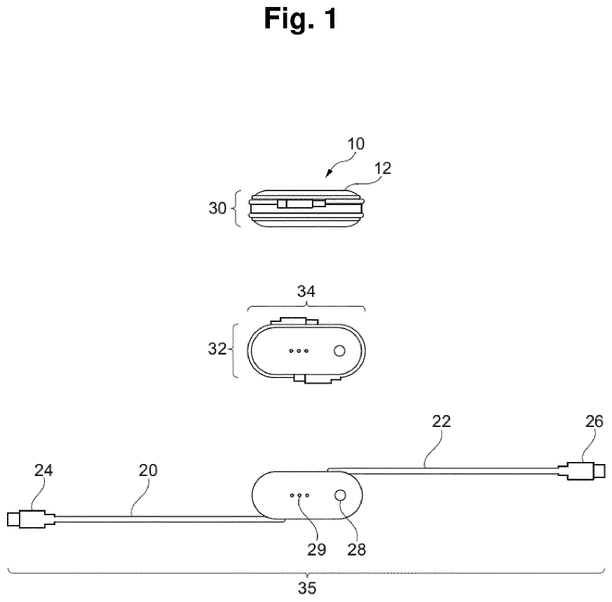

FIG. 1 shows a charging device of the present invention;

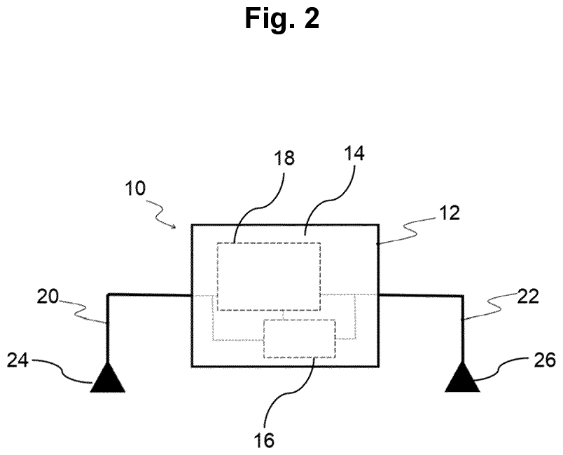

FIG. 2 shows a wiring scheme for the charging device of the present invention;

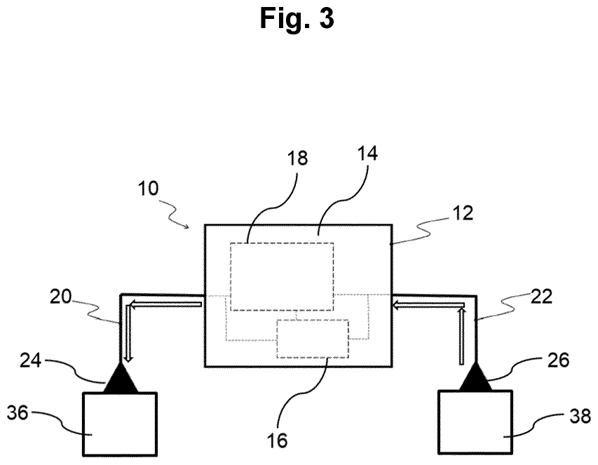

FIG. 3 shows a first use case for the charging device;

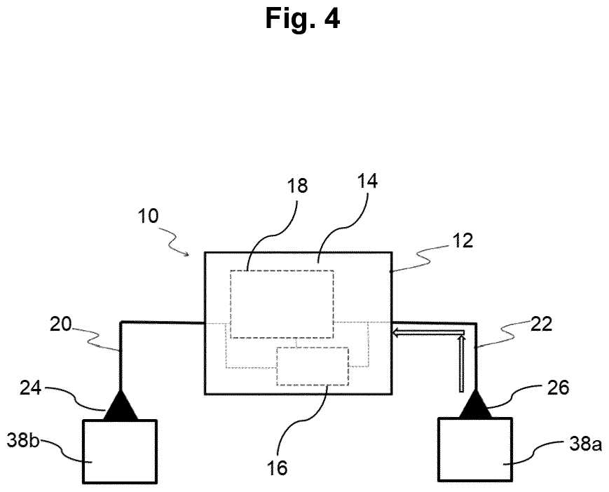

FIG. 4 shows a second use case for the charging device; and

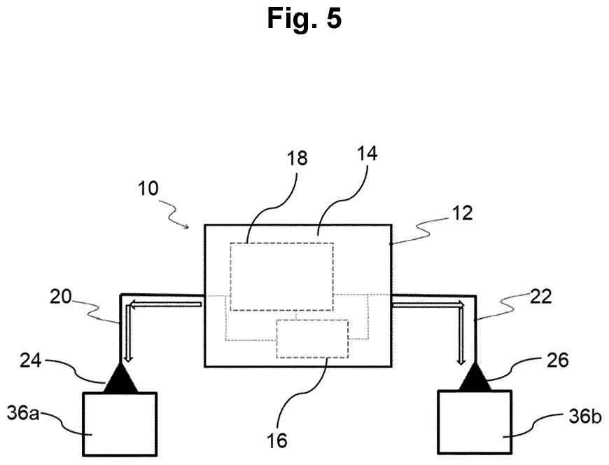

FIG. 5 shows a third use case for the charging device.

In FIGS. 1 and 2 a charging device 10 and a corresponding wiring scheme according to an embodiment of the present invention are depicted. The charging device 10 comprises a housing 12 with electronic circuitry 14. The electronic circuitry 14 includes a control unit 16 and a rechargeable battery 18.

The charging device also comprises two connection cables 20, 22. At the free end of each connection cable 20, 22 there is provided a connector 24, 26. The two connectors 24, 26 are identical to each other.

The housing 12 of the charging device 10 is made from synthetic material and has an oval cross-section. The housing 12 has a thickness 30 of about 25 millimeters, a width 32 of about 30 millimeters and a length 34 of about 68 millimeters. The maximum length 35 of the charging device 10 with fully unwound connection cables 20, 22 amounts to about 350 millimeters.

The connection cables 20, 22 are electrically connected to the electronic circuitry 14 in the housing 12. As shown in the top view of FIG. 1, the two connection cables 20, 22 are arranged offset from each other with respect to the thickness dimension of the housing. The cables may be wound around the housing 12 as depicted in the top and the middle view of FIG. 1. In this configuration, the full length of the connection cables 20, 22 is safely wound-up within and protected by the housing 12. The connectors 24, 26 are received in oppositely arranged recesses at the circumferential side surface of the housing 12 of the charging device 10. In this configuration the charging device 10 can conveniently be placed in a user's pocket.

In order to use the charging device 10, a user may unwind the connection cables 20, 22 from the charging device 10 by grasping and pulling the two partly protruding connectors 24, 26 from the housing 12 as depicted in the lowermost view of FIG. 1.

The housing 12 further comprises a power switch 28 and a graphical display 29. The power switch 28 may be used to activate the charging device 10. The graphical display 29 comprises three light emitting diodes that may be used to indicate operational status of the charging device 10.

The two connectors 24, 26 provided at the free ends of the two connection cables 20, 22 are identical. A user may connect the charging device 10 to a rechargeable electronic device. The user can use either of the connectors 24, 26 to establish such connection. The control unit 16 is configured to detect that a rechargeable electronic device is connected to either of the connection cables 20, 22 and starts the charging process accordingly.

A user may also connect the charging device 10 to an external power supply. Also in this case, the user can use either of the connectors 24, 26 to establish such connection. The control unit 16 is configured to detect that an external power supply is connected to either of the connection cables 20, 22 and may start to charge the internal rechargeable battery 18 using the electrical energy provided by the external power supply.

As illustrated with FIGS. 3 to 5 it is also possible to connect a secondary device to each of the two connectors 24, 26 of the charging device 10. The control unit 16 is configured to detect which kind of secondary device is connected to which connection cable 20, 22 and is further configured to manage the charging processes accordingly.

In the case depicted in FIG. 3 a portable rechargeable device 36 is connected to connection cable 20 and an external power source 38 is connected to connection cable 22. The control unit 16 is configured to detect that a portable rechargeable electronic device 36 and an external power source 38 are connected to the two connection cables 20, 22. In this case the control unit 16 will use the electrical energy provided from the external power source 38 to charge the rechargeable electronic device 36 by bypassing the internal rechargeable battery 18 of the charging device 10. The flow of electric energy is illustrated with the arrows in FIG. 3.

Once charging of the rechargeable electronic device 36 is completed the control unit 16 terminates charging of the rechargeable electronic device 36 and may start to charge the internal rechargeable battery 18 of the charging device 10. When the internal rechargeable battery 18 is fully charged, charge flow to the internal rechargeable battery 18 is interrupted.

With the charging device 10 of the present invention, the user does not have to pay attention anymore to which of the secondary electronic devices is to be connected to which of the connection cables 20, 22 of the charging device 10. The charging device 10 automatically detects what kind of secondary electronic device is connected to which connection cable 20, 22 and manages the flow of electric energy accordingly. Thus, handling and operation of the charging device 10 of the present invention is much simpler and more effective as compared with existing charging devices.

FIG. 4 shows a situation in which two external power sources 38a,b are connected to the charging device 10. Again, the control unit 16 is configured to detect the type of the connected secondary devices. Since no rechargeable electronic device is plugged in, the charging device 10 is configured to use the electrical energy provided by one of the power sources 38a,b to charge the internal rechargeable battery 18 of the charging device 10. For example the energy from the external power source 38a,b plugged in first may be used for this charging process. In the case depicted in FIG. 4 power source 38a which is connected to connection cable 22 has been plugged in first. Therefore, as indicated with the arrows 40 in FIG. 4, electrical energy from external power source 38a is used to charge the internal rechargeable battery 18 of the charging device 10.

The other external power source 38b is not used in this case. The control unit 16 of the charging device 10 is configured to prevent passage of electrical energy from the second external power source 38b. When the internal rechargeable battery 18 is fully charged, charge flow to the internal rechargeable battery 18 is interrupted. In this way the danger of short circuiting the two external power sources 38a, 38b is avoided.

FIG. 5 shows a situation in which two rechargeable electronic devices 36a,b are connected to the charging device 10. Again, the control unit 16 is configured to detect the type of the connected secondary devices. Since no external power supply is connected, the charging device 10 is configured to use the electrical energy of its internal rechargeable battery 18 to charge the two connected rechargeable electronic devices 36a,b. The control unit 16 of the charging device 10 is configured to charge only one of the rechargeable electronic devices 36a,b at a time. In this case, rechargeable electronic device 36a, which has been first connected to the charging device 10, is charged. At the end of this first charging process, if there is any electrical power left in the internal rechargeable battery 18 of the charging device 10, the control unit 16 is configured to start charging of the second rechargeable electronic device 36b. When both of the two connected rechargeable electronic devices 36a,b are fully charged, charge flow to these devices is interrupted.

1. Charging device for a rechargeable electronic device comprising
a housing with electronic circuitry including a control unit and a rechargeable battery, and
at least two connection cables,
wherein the first end of each connection cable is electrically connected to the electronic circuitry within the housing of the charging device, and the second end of each cable being provided with a connector,
wherein the connectors at the second ends of the connection cables are identical, wherein each connector cable is configured for charging and discharging, and wherein the control unit is configured to detect whether a power source or a rechargeable electronic device is connected to any of the connection cables of the charging device, wherein the rechargeable electronic device to be charged is a portable electronic aerosol-generating device.

2. Charging device according to claim 1, wherein the charging device is a portable charging device.

3. (canceled)

4. Charging device according to claim 1, wherein the connectors are USB type connectors, preferably USB Type-C connectors.

5. Charging device according to claim 1, wherein the control unit is configured to detect that a rechargeable electronic device is connected to one of the connection cables, and wherein the control unit is further configured to charge such connected rechargeable electronic device.

6. Charging device according to claim 1, wherein the control unit is configured to detect that a power source is connected to one of the connection cables, and wherein the control unit is further configured to allow charging of the internal rechargeable battery from such connected power source.

7. Charging device according to claim 1, wherein the charging device is configured to bi-directionally transfer data between connected devices

8. Charging device according to claim 1 any one of the preceding, wherein when the device is not in use, the connection cables are wound inside the housing of the charging device, wherein the housing comprises a winding mechanism for winding the connection cables.

9. System comprising a charging device according to claim 1 and a rechargeable electronic device being connectable to the connectors of the connection cables of the charging device.

10. Method of handling a charging device, the charging device comprising
a housing with electronic circuitry including a control unit and a rechargeable battery, and
at least two connection cables,
wherein the first end of each connection cable is electrically connected to the electronic circuitry within the housing of the charging device, and the second end of each cable being identical, and wherein each connector cable is configured for charging and discharging;
the method comprising
connecting at least one of the cables to a rechargeable electronic device or a power source,
detecting, by the control unit, whether the cable is connected to a rechargeable electronic device or a power source,
initiating the charging process after connection of one of the cables to the rechargeable electronic device or the power source,
wherein the rechargeable electronic device to be charged is a portable electronic aerosol-generating device.

11. Method according to claim 10, wherein upon detection that a power source is connected to the charging device, the power provided by such power source is used for a charging process.

12. Method according to claim 10, wherein upon detection that only a power source is connected to the charging device, using the power provided by such power source to charge the internal rechargeable battery of the charging device.

13. Method according to claim 10, wherein upon detection that a rechargeable electronic device is connected to the charging device, the rechargeable electronic device is charged from the rechargeable battery of the charging device.

14. Method according to claim 10, comprising
connecting the two connection cables to two devices, and
detecting, by the control unit, whether the devices are two power sources, two portable devices to be charged or whether the devices are one power source and one portable device to be charged.

15. Method according to claim 14, wherein upon detection that the two devices are a power source and a portable device, automatically determining which device is to be charged and starting the charging process of the portable device, using the power provided by the connected power source.
